(19) United States
(12) Patent Application Publication
(10) Pub. No.: US 2022/0266375 A1
(43) Pub. Date: Aug. 25, 2022

(54) METHOD AND SYSTEM OF FULLY BONDED STIFFENING PATCHES FOR AUTOMOTIVE STRUCTURAL COMPONENTS

(71) Applicant: MAGNA INTERNATIONAL INC., Aurora (CA)

(72) Inventors: Stuart Alexander CREWDSON, Shelby Township, MI (US); Darren Andrew WOMACK, LaSalle (CA); Edward SCHLEICHERT, Munchen (DE); Nikhil BOLAR, Royal Oak, MI (US)

(21) Appl. No.: 17/631,719

(22) PCT Filed: Aug. 6, 2020
(86) PCT No.: PCT/US2020/045186

§ 371 Date: Jan. 31, 2022

Related U.S. Application Data
(60) Provisional application No. 62/883,830, filed on Aug. 7, 2019.
(60) Provisional application No. 62/891,641, filed on Aug. 26, 2019.

(51) Int. Cl. B23K 11/00; B23K 11/06; B23K 1/00

(52) U.S. Cl. CPC B23K 11/004; B23K 11/061; B23K 1/0008; B23K 2101/006

(57) ABSTRACT

A vehicle structural component is provided having a substrate with one or more patches applied thereto. The thickness of the structural component is thicker and has added stiffness at the locations of the patches. The patches are bonded to the substrate via full surface bonding. The full surface bonding may be achieved via brazing, resistance seam welding, or adhesive bonding. A bonding layer may be disposed between the patches and the substrate. The patches and the substrate may be bonded via resistance seam welding, where a current and pressure are applied by weld wheels. The patches may be applied to the substrate in the form of a blank, or may be applied after the substrate has been formed and shaped into the vehicle component. The fully bonded patches provide comparable stiffness as a solid material having the same thickness.

### CROSS-REFERENCE TO RELATED APPLICATIONS

This PCT International Patent application claims the benefit of and priority to U.S. Provisional Patent Application Ser. No. 62/883,830 filed on Aug. 7, 2019, and titled “Method For Using Multiple Resistance Seam Welding Heads To Bond Patches,” and U.S. Provisional Patent Application Ser. No. 62/891,641 filed on Aug. 26, 2019, and titled “Fully Bonded Stiffening Patch For Automotive Structural Components,” the entire disclosures of which are hereby incorporated by reference.

### FIELD OF THE DISCLOSURE

The present disclosure relates to automotive vehicle structures. More particularly, the present disclosure relates to automotive structural components.

### BACKGROUND OF THE DISCLOSURE

Automotive vehicles, including vehicles powered by internal combustion engines, electric vehicles powered by batteries, and hybrid vehicles, include a variety of components that are assembled together to define the overall vehicle. The various components may include the engine, drivetrain, differential, control systems, and the like. Additionally, the vehicle is made up of many structural components that define the vehicle shape, which can also be referred to as the vehicle body.

Vehicles are typically constructed in stages, with different portions of a vehicle being assembled in different locations and at different times. This type of modular assembly process provides efficiency benefits for assembling the vehicle.

Accordingly, different modular portions may be assembled for a later overall assembly. One modular portion of the vehicle is the vehicle chassis. The vehicle chassis may include a structural component commonly referred to as a cradle. The cradle provides structure support to a variety of components and vehicle sub-assemblies, which can be mounted to the cradle prior to the final assembly. Once mounted to the cradle, additional components or subassemblies may be mounted to the cradle. At a later time, the vehicle body may be ultimately attached to the cradle as part of the vehicle assembly process.

When assembled, each vehicle component must be able to withstand the various loads and forces that occur during typical vehicle use, such as impacts loads, acceleration loads, bumps, and the like. In response to undergoing loads during use, these vehicle components can in turn result in loads being applied to the cradle to which they are mounted. Heavier components may cause additional loads relative to lighter components.

Additionally, different vehicle constructions and installed components can result in different stiffness requirements for the cradle or sub-frame. These stiffness requirements can drive the sizing requirements for the cradle or sub-frame.

Vehicle cradles are typically made of a strong and stiff material, such as steel, to be able to sufficiently withstand the various loads that occur during typical vehicle use and provide the necessary stiffness. The cradle may be stamped from a particular sheet of steel material to define the overall shape of the cradle that can receive the various components thereon.

Due to the varying load levels and stiffness requirements undergone by the cradle due to different attached components, some portions of the cradle receive higher loads and/or require different stiffness than others. The cradle is typically designed and manufactured to be able to withstand the highest load levels undergone by the cradle as well as the highest stiffness requirements. Efforts have been made to distribute the load across the cradle in order to reduce the overall weight of the cradle by using a thinner gauge of material along the cradle body.

However, it is typically not possible to distribute the load and design the cradle such that each portion of the cradle undergoes the same loads and require the same stiffness. Accordingly, some portions of the cradle are more robust than necessary, because the load requirements and stiffness requirements in those areas are lower. Reducing the thickness of the cradle overall will result in the cradle not being able to withstand the higher loads and/or stiffness requirements at other areas. A cradle with a higher thickness can have material removed in the reduced load areas, however such actions can be time consuming, difficult, and expensive. Moreover, excess material is necessary for the initial build prior to material removal, increasing initial cost outlays, with the excess material being costly waste.

Other automotive structural components can similarly include varying requirements for strength, stiffness, and the like at the different locations of the component. For example, these components may include a body-in-white component, a bumper, a closure panel, the B-pillar, A-pillar, C-pillar, etc. Various vehicle testing standards include requirements for crash resistance and specific crumple characteristics, which can also lead to differing desired thickness at different locations of the vehicle structural component.

In view of the above, improvements can be made the design and manufacture of vehicle structural components that can satisfy variable stiffness requirements that occur across the structural component without being overly heavy or robust at areas with reduced stiffness requirements.

### SUMMARY

In one aspect, a vehicle structural component is provided comprising: a substrate of the vehicle structural component, the substrate having a substrate thickness; at least one patch member having a size and shape smaller than the substrate, the at least one patch member having a patch thickness; wherein the at least one patch member is bonded to the substrate via a full surface bond between the patch member and the substrate; and wherein a total thickness of the vehicle structural component includes the patch thickness and the substrate thickness at the location of the patch member.

In one aspect, the component includes a bonding layer disposed between the patch member and the substrate.

In one aspect, the bonding layer is brazed and fully wetted between the patch member and substrate.

In one aspect, the bonding layer is an adhesive layer.

In one aspect, the at least one patch member is bonded to the substrate via resistance seam welding.

In one aspect, the stiffness and tensile strength of the structural component at the location of the patch member is at least 90% of the stiffness and tensile strength of a single component having a thickness equal to the total thickness of the patch and the substrate.

In one aspect, the thickness of the structural component varies.

In one aspect, the thickness of the substrate defines a minimum thickness of the structural component.

In one aspect, the stiffness at the minimum thickness of the substrate is less than the stiffness at a location of the patch.

In another aspect, a method of providing variable thickness to a vehicle structural component is provided, the method comprising: providing a substrate having a substrate thickness; providing a patch having a patch thickness; applying the patch to the substrate; and fully bonding the patch to the substrate.

In one aspect, the patch includes a bonding layer disposed on the surface of the patch and the bonding layer is disposed between the patch and the substrate.

In one aspect, the patch is bonded to the substrate via resistance seam welding.

In one aspect, the patch is bonded to the substrate via adhesive bonding.

In one aspect, the patch is bonded to the substrate via brazing.

In one aspect, the method include applying at least one pair of conductive weld wheels against the patch and the substrate on opposite sides thereof and applying current and pressure thereto.

In one aspect, the at least one pair of weld wheels comprises a single pair of weld wheels, the method further comprising applying the single pair of weld wheels along a first path to create a first weld nugget along the first path, and applying the single pair of weld wheels along the second path to create a second weld nugget.

In one aspect, the first and second path are parallel and adjacent, such that the first and second weld nuggets combine to define a continuous surface bond.

In one aspect, the at least one conductive weld wheel comprises: a first pair of weld wheels being radially aligned and defining a first space radially therebetween; and a second pair of weld wheels being radially aligned and defining a second space radially therebetween; wherein the first and second pairs of weld wheels are offset laterally and roll in the same direction; wherein the first and second pairs of weld wheels are configured to receive a patch and a substrate within the first and second space simultaneously.

In another aspect, a system for creating a full surface bond between a substrate and a patch is provided, the system comprising: a first pair of weld wheels being radially aligned and defining a first space radially therebetween; and a second pair of weld wheels being radially aligned and defining a second space radially therebetween; wherein the first and second pairs of weld wheels are offset laterally and roll in the same direction; wherein the first and second pairs of weld wheels are configured to receive a patch and a substrate within the first and second space simultaneously.

In one aspect, the first and second pairs of weld wheels are axially offset.

In one aspect, the first and second pairs of weld wheels are axially aligned.

In one aspect, the substrate is provided in blank form. In another aspect, the substrate is provided in a shaped form.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a vehicle cradle with a contour plot showing different stiffness requirements for different zones of the cradle based on computer modeling;

FIG. 2 is a perspective view of a perimeter cradle having increased thickness at different areas of the cradle;

FIG. 3 is another perspective view of the perimeter cradle;

FIG. 4 is another perspective view of the perimeter cradle;

FIG. 5 is a schematic representation of patches applied to a panel to increase thickness in localized areas;

FIG. 6 is another schematic representation of patches applied to a panel to increase thickness in localized areas;

FIG. 7 is a schematic view of resistance seam welding, illustrating a patch with a plating layer bonded to a substrate, with conductive weld wheels applying current and pressure to the patch and substrate;

FIG. 8 illustrates multiple weld wheels for bonding the patch to the substrate;

FIG. 9 illustrates one example of a full surface bond between a patch and a substrate;

FIG. 10 illustrates coupons taken from a bonded patch and substrate for testing;

FIG. 11 illustrates a coupon for tensile testing;

FIG. 12 illustrates a coupon for bending testing;

FIG. 13 illustrates a coupon for use with a micrograph;

FIGS. 14 and 15 illustrate coupons for lap shear testing;

FIG. 16 illustrates coupons being cut in the direction of travel of the weld wheels that bonded the patch to the substrate;

FIG. 17 illustrates coupons being cut in a direction transverse to the direction of travel of the weld wheels;

FIGS. 18-22 illustrate graphs and tables of testing results of different coupon arrangements; and

FIGS. 23A-B illustrates micrographs of the patch and substrate after bonding.

### DETAILED DESCRIPTION

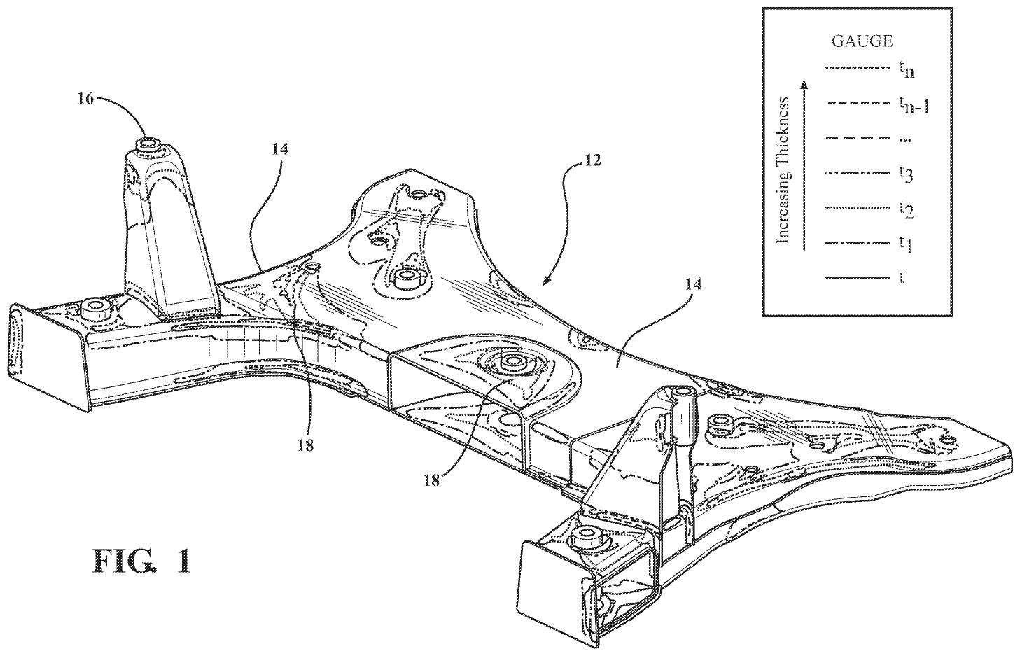

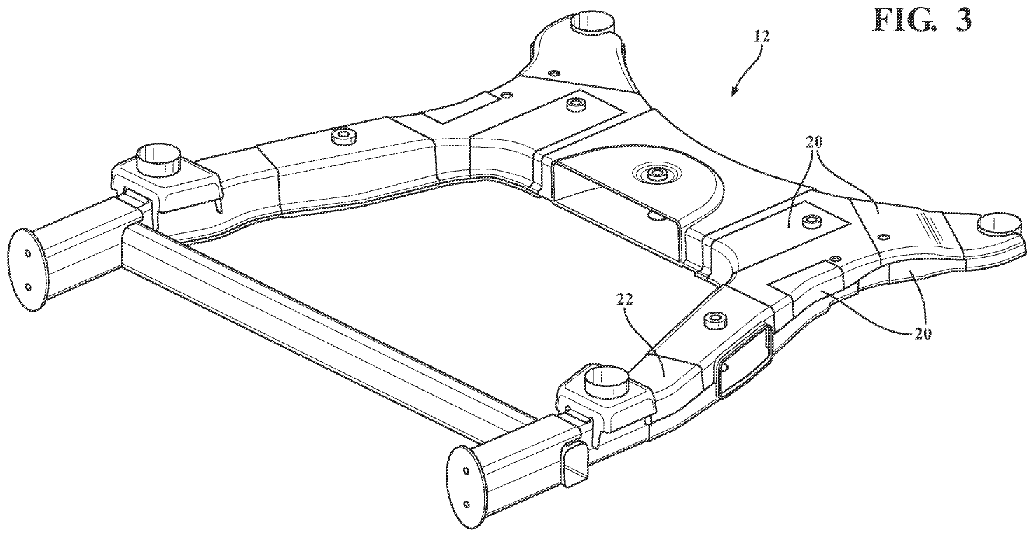

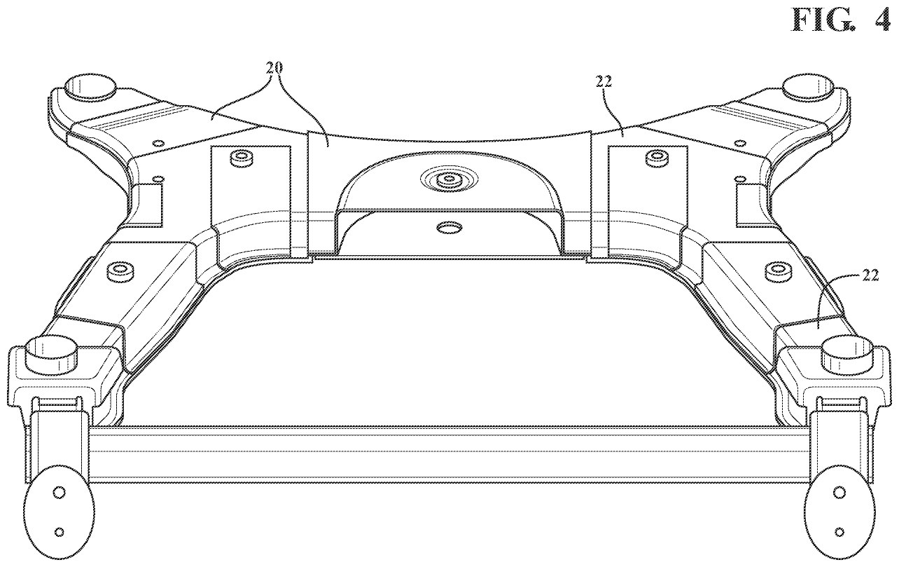

With reference to FIGS. 1-4, a system 10 for supporting a variety of vehicle components includes a vehicle structural component 12, illustrated as a cradle 12 sized and arranged to accommodate a predetermined layout of vehicle components and payload. The cradle 12 is configured to have a variable thickness at different locations depending on the predetermined layout and expected loads corresponding to the predetermined layout. The variable thickness of the component 12 or cradle 12 may be created using fully bonded stiffening patches 20 that are applied to a base sheet of material or substrate 22. The patches 20 may be bonded to the substrate 22 via a full surface bond. The full surface bond may be provided by resistance seam welding, as described in further detail below.

It will be appreciated that various vehicle types include a variety of different vehicle components. Accordingly, the specific arrangement of the vehicle cradle 12 and its variable thickness as described herein is dependent on the arrangement of said various components. It will be further appreciated that the various components and predetermined layout may be arranged such that the vehicle cradle 12 will have different load and stiffness requirements at different areas, and that such requirements may be determined via computer modeling or the like, with specific regions being identified as having relatively higher or lower load requirements. Areas with relatively higher load and stiffness requirements will typically require a greater thickness. Reference will be made herein to the various vehicle cradles 12 illustrated; however it will be appreciated that the specific shapes of the cradle 12 and the variable thicknesses are exemplary and not limiting to the specific cradles and thickness shown.

It will be further appreciated that the combination of patches 20 with a vehicle substrate 22 or substrate 22 may be applied to other vehicle structural components and are not limited to the chassis, sub-frame, cradle, or the like. For example, various body frame components, such as A-pillars, B-pillars, and the like may have fully bonded stiffening patches 20 to increase thickness and stiffness at selected areas.

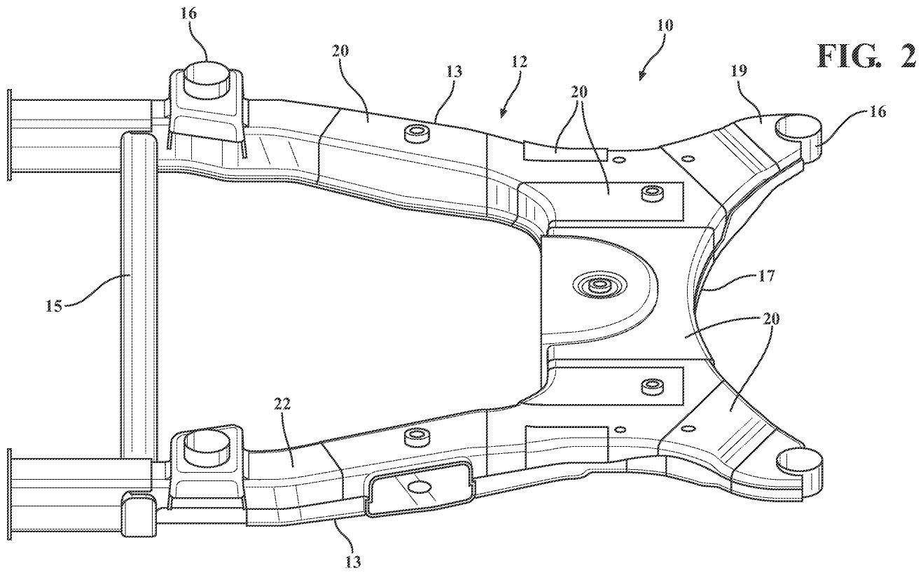

In one aspect, the cradle 12 may have a generally box-like overall shape defined by a plurality of linking structure, sections, or sections 14, as shown in FIG. 2, or a shortened shape, as shown in FIG. 1. It will be appreciated that other structural shapes may also be used. In one aspect, the box-like shape shown in FIG. 2 may be referred to as a “perimeter” cradle, and the elongate shape of FIG. 1 may be referred to as a “K-frame.”

The sections 14 may combine to define the overall shape and layout of the cradle 12 and may also define a plurality of mounting locations 16 (such as sleeves, bushings, holes, or the like) for various vehicle components. The cradle 12 may be a perimeter cradle (FIGS. 2-4), a k-frame cradle (FIG. 1), or other vehicle sub-frame component. The cradle 12 is configured to support various vehicle components as a sub-assembly, and is further configured to isolate other portions of the vehicle from loads and vibrations generated by the various vehicle components.

The cradle 12 illustrated in FIG. 1 is a specific cradle illustration for a specific layout of components, and is provided for illustrative purposes. Furthermore, FIG. 1 is provided to illustrate an example of different load requirements at different locations of the cradle 12, as determined via computer modeling or the like. Areas with different load and stiffness requirements are shown with shading indicating increased load and stiffness requirements, and therefore increased thickness is desirable in these areas.

The sections 14 making up the cradle 12 shape may accordingly include a plurality of zones 18 distributed along the sections 14. The zones 18 may be defined relative to each other as areas of the cradle 12 (or the sections 14 thereof) where different gauges or thicknesses are preferable to account for increased loads at the various zones 18. Accordingly, different zones 18 may have different load requirements, and correspondingly different thickness requirements.

As described above, the cradle 12 of the present disclosure is configured as a variable gauge cradle, such that different zones 18 may have different thicknesses. The specific thickness for selected zones 18 may be determined based on CAE modeling (Finite Element Analysis) and/or CAD modeling. Based on the modeling of the cradle 12, it may be determined which of the zones 18 require relatively large thicknesses and which of the zones 18 require relatively small thicknesses. It will be appreciated that the actual thicknesses of various zones 18 may depend on the specific design and shape of the cradle 12, as well as the specific components intended to be installed on the cradle 12 and the locations of these components. Accordingly, across different vehicle types and installations, the zones 18 that require a thicker gauge will be different from vehicle to vehicle and the various components intended to be installed. FIG. 1 illustrates one example of a cradle 12 having multiple zones with different stiffness and load requirements, and therefore different thicknesses.

In one aspect, the cradle 12 may have an “infinitely variable” thickness. In this approach, the CAE modeling may identify various zones and a preferred thickness at each zone 18, relative to a baseline thickness. In one example, the cradle 12 may have a thickness that ranges from 1 mm to 5 mm. The thicknesses may be determined using a stiffness based optimization program. The minimum thickness may be 1 mm, with the CAE modeling determining in which zones 18 the thickness shall be increased relative to the minimum thickness. The size and shape of the zones 18 having different thicknesses may depend on the modeling. In one example, a baseline reference mass for a similar cradle without variable thickness may be 25 kg, with a final mass as determined by the CAE model of a variable thickness cradle 12 being 18.6 kg using the stiffness based modeling and infinitely variable thickness of the cradle 12, such that a 6.4 kg mass savings is realized. The reduction in overall weight is due to the traditional cradle having extra thickness in regions or zones 18 where such thickness is unnecessary, such that the baseline thickness is higher than necessary relative to a variable thickness cradle. The variable thickness cradle 12 may have a baseline thickness that is relatively lower than the traditional cradle, with increased thickness in select locations, thereby requiring less material and resulting in lower overall weight. In several structurally sensitive zones, the select locations where additional material is also added includes along the radiuses of the formed sheet metal.

In a related example, CAD modeling may be used based on FEA results. In this example, thickness less than 1.5 mm may be set at 1 mm, thicknesses between 1.5 and 2.5 mm may be set at 2 mm, thicknesses between 2.5 and 4.5 may be set at 3.5 mm, and thicknesses greater than 4.5 mm may be set at 5 mm. Thus, the gauge range for the cradle 12 is still between 1 and 5 mm, but with specific stepped thicknesses to address different ranges of the results of the CAE modeling. In this approach, the baseline reference mass is 25 kg (the same as above), and the final mass of the CAD model is 20.7 kg, for a mass savings of 4.3 kg. Thus, there is still a mass savings realized relative to the initial baseline, although the mass savings is less than the “infinitely variable” thicknesses.

In the above CAD modeling example, thickness of the cradle 12 may be built up in layers having fixed thicknesses, resulting in stepped differences in thickness between different zones 18.

Of course, it will be appreciated that while the infinitely variable thickness is preferable, in practice, localized thicknesses based on ranges may be easier to implement. One approach to increasing thickness in localized zones may be accomplished using patches 20, as further described below.

With reference to FIG. 2, a plurality of patches 20 are shown applied to the cradle 12 to increase the thickness of the cradle 12 at select locations. The patches 20 may have varying thicknesses, depending on the desired overall thickness of a specified area of the section 14 or portion of the cradle 12. The patches 20 may be bonded/fused/unified to a base sheet 22 or substrate 22 or substrate 22 of material via a full contact bond (area fusion), such that the patches 20 may be used to locally thicken specific areas. In this aspect, patch 20, made of metal, is placed and bonded on the parent panel or substrate 22 (also referred to as a sheet or base sheet). It will be appreciated that various types of full contact bonding may be utilized to bond the patches 20 to the substrate 22.

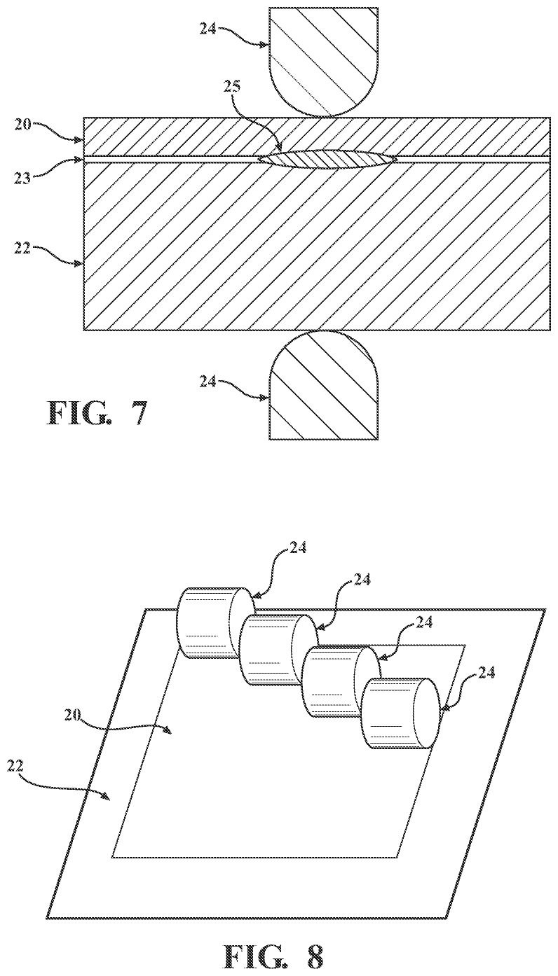

In one aspect, the thickness of the base sheet may be the minimum gauge of the sheet of material forming the panel portion of cradle 12, which may also be referred to as the baseline thickness. In the above examples (with a range of 1 mm to 5 mm), the thickness of the substrate 22 may be 1 mm. The thickness of the patch 20 may be the difference between the desired gauge or thickness and the thickness of the substrate 22. Accordingly, in the above examples, for the zone 18 where a 2 mm thickness would be desired used, the patch 20 may be 1 mm thick and applied to the 1 mm substrate 22. For the zone 18 that is 5 mm thick, the patch 20 may be 4 mm thick and applied to the 1 mm substrate 22. Various other patch thicknesses may be used in other zones 18. In the case of a thicker patch 20, the stepped difference in thickness relative to the baseline thickness is greater than for thinner patches 20. The stepped difference in thickness may be reduced, eased, or transitioned by layering multiple patches 20 over each other, with these patches having different perimeter sizing or surface areas. FIGS. 8-10 schematically illustrate different arrangements and numbers of patches, which are described in further detail below.

In one aspect, multiple patches 20 may be applied in a stack to reach the desired overall thickness. For example, for a 5 mm zone, four 1 mm thick patches 20 may be applied to the 1 mm thick substrate 22. The edges or adjacent stacked layers of patches 20 may be offset relative to each other, thereby allowing for an eased transition from the baseline thickness to the maximum thickness of the zone 18.

Accordingly, the use of the patches 20 in localized areas allows for the ability to create parts, components, or subframes, such as the cradle 12, with a variable thickness throughout. The patches 20 may be used to locally thicken various portions of the sub-frame or cradle 12. By using defined stiffness targets for the cradle 12, patch level and element (small discretized structural unit) level gauge optimization may be used to identify areas or zones 18 of the sub-frame or cradle 12 that can benefit from varying thickness. Accordingly, if a single area or zone 18 requires an increased gauge or thickness, it may be locally thickened rather than having to increase the gauge or thickness of the entire component, thereby saving on overall mass and increasing product performance.

According to analysis of this approach, a perimeter type cradle 12 may save about 8% of mass, and a k-frame type cradle may save from 1-5% of mass when using the patches 20 to locally thicken zones 18 from a baseline thickness. For an infinitely variable gauge or thickness design with gauges ranging from 1.6-5 mm, perimeter cradles 12 may save 14% of mass, with k-frame cradles 12 saving about 11%. Of course, the specific weight savings relative to traditional cradles is dependent on the actual weight of the traditional cradle design and the specific layout of components across the cradle 12. However, as illustrated, some degree of weight savings relative to a traditional cradle may be realized by selectively increasing thickness from a reduced baseline thickness is made possible by the present disclosure.

In another example, when modeling the cradle 12 with stiffness based optimization, but with a gauge range of 1.6-5 mm rather than 1-5 mm, there are fewer zones 18 in which increased thicknesses are identified. The baseline thickness in this approach, being thicker at 1.6 mm vs 1.0 mm in the previous example, therefore requires fewer areas where increased thickness is desired. In an infinitely variable approach, there are still multiple zones 18 in which increased thickness is necessary. Again, the baseline mass of the cradle 12 is 25 kg, with the mass of the infinitely variable cradle 12 being reduced in this case to 21.4 kg, for a 3.6 kg mass savings.

In another example, another approach to varying thickness of the cradle 12 using patches 20 may be used. In this approach, the gauges range from 1.0 to 5 mm. The cradle 12 is split into multiple zones 18 based on the average thickness. The baseline mass is 25 kg, with the resulting mass of this approach being 22.7 kg, for a mass savings of 2.3 kg. The minimum thickness is 1.0 mm, with a variety of different thicknesses disposed around the cradle 12, up to a thickness of 5 mm. Other zones 18 have a thickness that is between 1 and 5 mm. In this approach, single patches 20 are used, with different patches 20 having different thicknesses to arrive at the overall thickness.

In the above-described models, the result of the variable thickness cradles is compared to a baseline mass. The baseline mass is based on an “original” thickness of the illustrated cradle 12, which is less than 4 mm. When modeling the desirable thickness for a variable thickness cradle 12, the maximum thickness may be set at the original thickness or may be set at a maximum thickness that is greater than the original thickness. The maximum thickness being greater than the original thickness for the same given layout of components allow the variable gauge cradle 12 to provide additional thickness and strength in zones 18 of need. In the traditional cradle, a thickness corresponding to the maximum thickness of the variable gauge would result in cradle 12 that is overly heavy.

When modeling with a maximum thickness based on the original thickness, the resulting necessary thickness is less variable, because a structural optimization process does not add larger thicknesses in certain areas. Accordingly, additional thickness is added in other areas to compensate.

When modeling with a maximum that is above the original thickness, for example with a maximum thickness of 4 mm, the thickness across the cradle 12 can vary more, because areas of need can be addressed specifically, and therefore other areas can have further reduced thicknesses.

For example, with the baseline mass of 25 kg, when the range is from 0.0 to 4 mm, the CAE modeled mass is below the baseline. When the range is from 0.0 to original thickness, the CAE modeled mass is below the baseline.

In another example, a CAE model of a k-frame style cradle 12 is used. The thickness ranges from 1.005 to 5.8 mm. Much of the cradle 12 has a minimum thickness, with various zones 18 having higher thicknesses. In particular, sleeves 16 (such as those shown in FIG. 1) are indicated at the maximum thickness. A baseline mass of this cradle 12 may be 20.0 kg, with the CAE modeled mass being 16.3 kg, for a mass savings of 3.7 kg.

In yet another model of the k-frame style cradle 12, the gauges range from 1.6 to 5 mm. In this example, a larger portion of the cradle 12 is at the minimum thickness, with fewer zones 18 having increased thickness relative to the previous example. The sleeves 16, again, may have maximum thickness. The baseline mass is 20.0 kg, and this model results in a mass of 17.7 kg, for a mass savings of 2.3 kg.

Thus, in view of the above, the variable gauge cradle 12 may provide the necessary stiffness of a typical cradle, but with reduced mass, by having localized areas or zones 18 with increased thickness. The increased thickness may be greater than the original thickness of the traditional cradle, allowing for reduced thicknesses in other areas.

Accordingly, a cradle or sub-frame may include a plurality of interconnected sections 14 that define a shape of the cradle 12, as shown in FIG. 2, for example. The sections 14 may have a first thickness disposed along a first portion of the sections 14, wherein the first thickness is a minimum thickness of the cradle 12 as defined by a substrate 22 of material. When referring to the thickness of the cradle 12, it will be appreciated that the thickness is in reference to the wall of the panel structure or cradle structure. The cradle 12 may be made up multiple sheets or material joined together to define a hollow beam shape or similar structure, and the thicknesses described are typically in reference to the wall structure that defines the hollow structure. The sections 14 may further include a second thickness disposed at a second portion of the sections 14. The sections 14 may further include a third thickness disposed at a third portion of the sections 14, wherein the third thickness is an intermediate thickness of the cradle 12. The second thickness may be greater than the first thickness and the third thickness. In one aspect, the second and third thicknesses are defined by a patch 20 applied to the base sheet of material, such that the combined thickness of the substrate 22 and the patch 20 (or patches 20) defines the thickness of the section 14 and the location of the layered patch(es) 20.

In another aspect, the variable thickness of the cradle 12 may be accomplished by other manufacturing methods other than additional sheets of material. For example, metal deposition techniques, such as cold spray or sintering (additive manufacturing methods), may be used to add thickness to identified local zones 18 of the cradle 12. The additional material may be built up on the substrate 22 and may define the patch 20.

In another aspect, the above-described variable gauge or thickness may be applied to other structural components of the vehicle other than the cradle 12. For example, the variable gauge approach may be applied to frame rails, B-pillars, and the like.

In view of the above, and with reference to FIGS. 2-4, one example of the cradle 12 is shown having patches 20 disposed at various locations in accordance with the increased load tolerance at different zones 18 as determined by modeling. The locations of the patches 20 are locations where increased thickness is determined to be desirable to account for increased load or stiffness requirements.

The cradle 12 shown in FIG. 2 may be considered to be a generic sub-frame component, shown in the form of a perimeter cradle. The cradle 12 is shown having a generally symmetrical shape relative to a fore-and-aft direction and includes first and second side portions 13. As shown, side portions 13 have a generally symmetrical arrangement. The side portions 13 are connected via a laterally extending support beam 15 and a front portion 17. The patches 20 disposed around the cradle 12 are also illustrated as being disposed symmetrically.

The cradle 12 further includes a pair of end sections 19 that extend outwardly from the front portion 17. The end sections 19 include support sleeves 16 configured for mating with additional vehicle structure. The cradle 12 forms a generally closed loop and includes an open space defined by the closed loop shape.

The side portions 13 also include support sleeves 16 configured for mating with additional vehicle structure. The portions 13, 15, 17 described herein may be in the form of generally hollow structures formed by an assembly of formed sheet metal portions, and may also be generally described as section 14.

Of course, it will be appreciated that while the infinitely variable thickness may be preferable for a cradle or the like, in practice, localized thicknesses based on ranges may be easier to implement. One approach to increasing thickness in localized zones may be accomplished using patches 20.

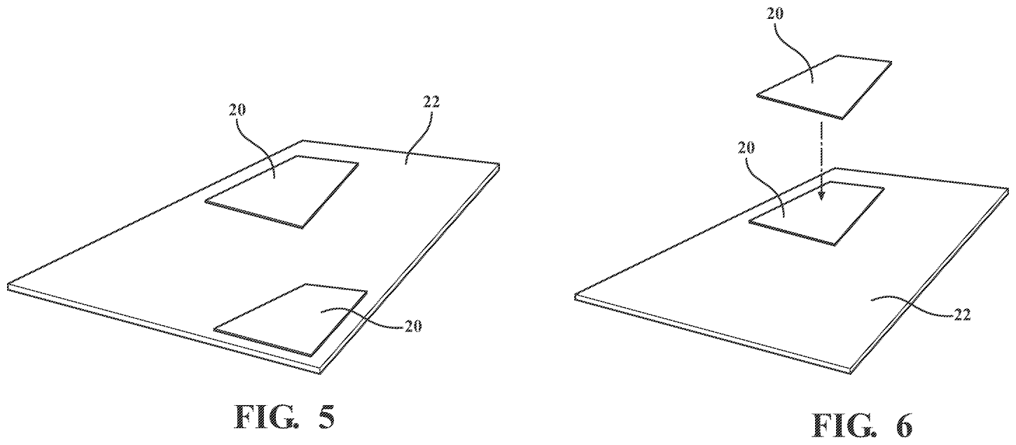

With reference to FIGS. 5 and 6, a panel or substrate 22 is schematically illustrated with a pair of patches 20 applied thereto. The patches 20 may have varying thicknesses, depending on the desired overall thickness of a specified area of the substrate 22. The patches 20 may be bonded to the substrate 22, such that the patches 20 may be used to locally thicken specific areas. In this aspect, patches 20, made of metal, are placed and bonded on the parent substrate 22 (also referred to as a sheet or substrate). It will be appreciated that various types of bonding may be utilized to bond the patches 20 to the substrate 22.

In one aspect, the patches 20 may be bonded to the substrate 22 via resistance spot welding. In resistance spot welding, the patch 20 is applied to the substrate/substrate 22, and a spot welding device passes a current through the patch 20 and the substrate 22, which melts the material of the patch 20 and substrate such that they are welded together at the location of the spot weld. Patches 20 may be applied to the substrate 22 via the spot welding, with spot welding occurring at a plurality of locations across the surface of the patch 20 to increase the bonded surface area of the patch 20.

Accordingly, the spot welding process that produces a single spot weld is repeated a number of times until a sufficient surface area between the patch 20 and the substrate 22 has been bonded. With enough spot welding locations, the patch 20 and the substrate 22 may be bonded together over a substantial portion of the surface area, increasing the strength of the bond between the patch 20 and the substrate 22. In this approach, the overall gauge of the component may be increased at the areas of the spot weld, with the overall gauge being approximately the thickness of the substrate 22 plus the thickness of the patch 20.

In one aspect, the patch 20 may be fully bonded to the substrate 22. To fully bond the patch 20 to the substrate 22, the patch 20 is applied to the substrate 22 and the entire surface area or substantially the entire surface area of the patch 20 is welded and/or bonded to the substrate 20. Full surface bonding may be accomplished in multiple ways. In one aspect, resistance seam welding may be used. In another aspect, brazing may be used. In yet another aspect, adhesive bonding may be used.

As described above, full surface bonding between the patch 20 and the substrate 22 may be accomplished using resistance welding. More particularly, resistance seam welding may be used. Resistance seam welding is another form of electric resistance welding.

Resistance seam welding is illustrated schematically in FIGS. 7 and 8, in which electrically conductive wheels 24 roll along a path or “seam.” The wheels 24 apply pressure between the patch 20 and the substrate 22 while conducting a current through the material, thereby causing the material of the patch 20 and the substrate 22 to melt and creating a fusion between the materials. The rolling of the wheels 24 along the path creates an essentially continuous bond along the path. Seam welding can be performed at the location of a butt-joint or over overlapping material. In the case of the patch 20 and the substrate 22, the overlapping material arrangement will typically be used. Full surface bonding may be achieved by performing multiple passes of the wheels 24. For example, a first pass may be performed, leaving behind an elongate welded area, with subsequent paths bordering previous paths to join with the previous welded area and adding to the surface area that has been welded to eventually create a full surface bond over the desired area.

Unlike spot welding, which uses a plurality of distinct spots across a surface, the seam welding technique creates a strip of bonded surface along the path that the wheels 24 travel. The seam welding process may be repeated to create a plurality of adjacent strips of bonded surface area. Due to the continuous length of the strips, far fewer welding steps are used relative to the spot welding process. Additionally, the continuous length of the strips provides for continuous coverage of the overlapping surface area between the patch 20 and the substrate 22, unlike a series of spot welds that may include gaps.

The width of the weld strip may be varied by the width of the wheels 24. Weld wheels 24 with a thinner width will produce a thinner weld strip, and wheels 24 with a wider width will produce a wider weld strip. The plurality of weld strips may be created sequentially, where a first weld strip is created, and the wheels 24 or the work piece is shifted, aligning the wheels 24 with the adjacent area to be welded. The plurality of weld strips need not necessarily be created adjacent the prior strip, but may also be offset and separate from the prior strip, with the gap that is created therebetween being filled by another weld strip at a later time.

In one aspect, the previously applied weld strip is allowed to cool and fully cure prior to application of the subsequent weld. The subsequent weld strip may have a path that partially overlaps the previously applied weld strip. Alternatively, the subsequent path may be aligned such that there is little to no overlap. Preferably, there are no lateral gaps between the weld strips after each of the intended weld strips are created. However, it will be appreciated that some nominal gaps may occur between adjacent weld strips.

If necessary, the wheels 24 may be returned to an area where a gap exists, such that the gap is eliminated by a further weld strip. Such additional or further welds strips may be created on an ad hoc basis in response to detecting an unintended gap, or the further weld strips to fill the gaps may be planned. For example, if it is desirable for the weld strips to be fully cured prior to applying an adjacent weld strip, weld strips may be created in a pattern such that a gap is intended to be created, and then the gap may be filled later after the two strips with the gap between them have cured.

The direction of the weld path is preferably in the direction where tensile strength is desired or the direction in which shearing loads may occur between the patch 20 and the substrate 22. Thus, the determination of the direction of the weld strip may vary depending on the type of structural component and its expected loads. However, the resulting weld and bond created by the seam welding is still robust in a direction transverse to the direction of the weld strips.

The resulting weld that occurs from the path of the weld wheels 24 may be wider than the width of the wheels 24. The heating of the material between the wheels 24 will cause material adjacent the wheels 24 to become heated, as well, which may lead to the adjacent material also melting and bonding. Accordingly, even if there is a nominal gap between the weld paths, the material in the area of the gap may still be bonded due to the heat that extends beyond the edges of the weld wheels 24.

In the above-described approach, the wheels 24 have been described as having paths that are generally parallel to each other and offset laterally to ultimately cover substantially the entire surface area of the bond. In another approach, subsequent weld paths may be used that are transverse to the direction of a previous weld path. For example, subsequent weld paths may be applied perpendicular to a previous weld path. For another example, subsequent weld paths may be at an oblique angle relative to other weld paths.

The above-described approach has referred to a single pair of wheels 24. However, in one aspect, multiple pairs of wheels 24, as shown in FIG. 8, may be applied at essentially the same time across the patch 20, such that the entire patch 20 may be bonded to the substrate 22 in a single pass of the overall plurality of wheels 24 FIG. 8 illustrates one side of the substrate 22. It will be appreciated that a corresponding set of wheels 24 may be disposed on the opposite side of the substrate 22 to create the resistance seam weld between opposing wheels 24.

The wheels 24 may be arranged laterally adjacent and axially aligned, such that they are applied to the patch 20 and the substrate at the same time. Alternatively, the wheels 24 may be staggered, such as that shown in FIG. 8, such that an adjacent wheel 24 follows shortly after the first wheel 24, and so on for additional wheels 24. In the case of weld wheels 24 that are axially aligned, the wheels 24 would be axially aligned in a left to right direction in FIG. 8. Such wheels 24 may be disposed on a common shaft. The wheels 24 of FIG. 8 that are axially offset may be disposed on a stepped shaft or other similar structure. In one aspect, the wheels 24 of FIG. 8 that are axially offset may be arranged such that that are axially offset a sufficient degree such that the wheels 24 may have a lateral overlap. However, such lateral overlap is not necessarily required because, as mentioned above, areas adjacent the edge of the wheels 24 may also be heated and welded. Accordingly, a gap may be disposed laterally between the wheels, with the area of the gap being heated by each of the adjacent wheels 24.

In another aspect, the patches 20 may be bonded to the substrate via a full surface bond created by brazing. Brazing involves joining two metal materials by melting an intermediate layer, which may also be referred to as a bonding layer 23. The material used for the bonding layer 23 in a brazing process may have a melting point that is lower than the melting point of the metals being joined. Brazing may provide a very strong bond between the same or different metals. In the brazing process, the metals themselves are not typically melted. Rather, the metals and the plating layer are heated to a temperature that is above the melting temperature of the brazing material but below the melting temperature of the metals being joined. Thus, the brazing material will melt, but the metals will not.

The brazing material, being melted between the metals to be joined, will thereby flow into the gaps formed between the metal parts. The brazing process may therefore be beneficially used with the patches 20 and the substrate 22. Upon melting and flowing into the gaps between the metal components, the brazing material will then be cooled, thereby creating a strong bond between the patch 20 and the substrate 22. Thus, a full surface bond between the base metals (the patch 20 and the substrate 22) may be formed by the brazing process.

In another aspect, as mentioned previously, full surface bonding between the patch 20 and the substrate 22 may be achieved via adhesive bonding. Similar to brazing and resistance seam welding, an adhesive layer of material may be disposed between the patch 20 and the substrate 22 across the entire surface of the interface therebetween. The adhesive layer may also be referred to as the bonding layer 23. The bonding layer 23 in the form of an adhesive layer may be applied to one of both of the patch 20 and substrate 22, such that when the patch 20 is placed on the substrate 22, the adhesive is disposed between them. Thus, the bonding layer 23 in the form of an adhesive may bond to both the patch 20 and the substrate 22, thereby joining the patch 20 to the substrate 22.

The adhesive bonding layer 23 may be in the form of a tape or peel-able layer that may adhere to one or both of the patch 20 and substrate 22, thereby allowing the bonding layer 23 to be applied to one of the components and then be later applied to the other of the components at the time of bonding. The adhesive bonding layer 23 may be activated in response to being heated to a target temperature (which is less than a melting temperature of the patch 20 or substrate 22). Similar to the brazing process, upon cooling, the adhesive bonding layer 23 may thereby provide a full surface bond between the patch 20 and the substrate 22.

The adhesive bonding layer 23 may be a single material that bonds to both the patch 20 and the substrate 22. In another aspect, the adhesive bonding layer 23 may be two different materials that individually may not provide for a bond between the patch 20 and the substrate 22. However, upon mixing the materials, the individual materials will combine to form an adhesive that bonds with both the patch 20 and the substrate 22.

The adhesive may be applied to the patch 20 and/or substrate 22 in a generally solid state, whereby upon heat or another activating event, the adhesive bonding layer 23 may provide a bond between the patch 20 and the substrate 22. In another aspect, the adhesive may be applied in a generally liquid form that may be “painted” or otherwise distributed across the surface of the interface between the patch 20 and the substrate 22. In one aspect, the adhesive may be applied generally evenly across the interface between the patch 20 and/or substrate. In another aspect, the adhesive may be applied such that it does not initially cover the entire surface of the interface, but upon pressure and or heating/activation, the adhesive will flow into the un-covered areas to thereby cover the full interface area between the patch 20 and the substrate 22.

Accordingly, in view of the above, the full surface bond between the patch 20 and the substrate 22 may be achieved via resistance seam welding, brazing, or adhesive bonding. Additionally, a full surface bond between the patch 20 and the substrate 22 may be accomplished by other bonding methods that may include a bonding layer that may be configured to cover the full area of the interface between the patch 20 and the substrate 22.

With reference again to the resistance seam welding process, and with reference to FIG. 7, in one aspect, the seam welding method may be a combination of resistance welding and brazing. The patches 20 may be coated with a nickel material by electroless plating. Alternatively, copper may be used. Other metals or alloys suitable as a braze material may also be used. The material may make up the bonding layer 23 applied to the patch 20. The bonding layer 23 may have a very small thickness relative to the patch. For example, the patch may be 2 mm thick, and the bonding layer 23 may be 11 micrometers. The bonding layer 23 may serve as the braze material. The electroless plating process allows for the application of the thin bonding layer 23.

The patch 20 may be applied to the substrate 22 with the bonding layer 23 facing the substrate 22 and contacting the substrate 22. Put another way, the bonding layer 23 is disposed between the patch 20 and the substrate 22. However, it will be appreciated that the patch 20 and bonding layer 23 that is applied to the patch 20 may also be referred to collectively as the patch 20.

Upon application of the current and force provided by the wheels 24 to the patch 20 and substrate 22 in the resistance seam welding process, a weld nugget 25, which may be in the form of a strip as described above, will be created at the location of the bonding layer 23, as shown in FIG. 7. FIG. 7 may also be interpreted as representing the other full surface bonds utilizing the bonding layer 23. In such instances, the weld wheels 24 of FIG. 7 may be excluded, and the weld nugget 25 may be interpreted as a bond after being brazed or adhered, with the bond or weld nugget 25 occurring across the bonding layer 23.

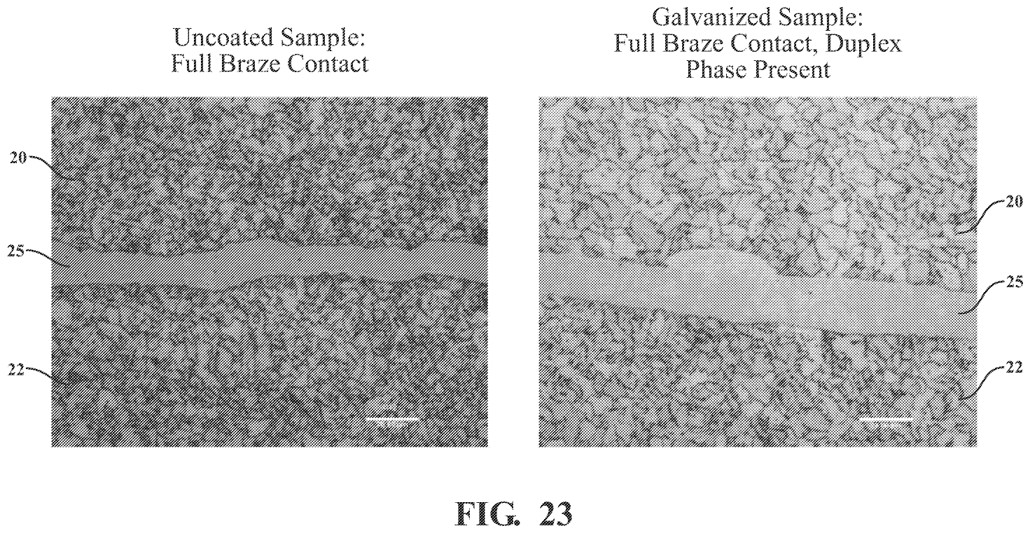

In one aspect, the substrate 22 may be made of galvanized steel. The patch 20 may also be made of galvanized steel. FIG. 23B illustrates an example of the bonding layer 23 being brazed to define a weld nugget 25 or bond between galvanized.

In another aspect, the substrate 22 may be made of uncoated steel. The patch 20 may also be made of uncoated steel. FIG. 23A illustrates an example of the bonding layer 23 being brazed to define a weld nugget 25 or bond between uncoated steel.

As described above, the patch 20 may be plated with the bonding layer 23. In another aspect, the substrate 22 may be plated with the bonding layer 23 in addition to or alternatively from the patch 20.

The patch 20 may have a variety of different shapes, depending on the shape of the substrate 22 or other component to which it is attached. For example, the patch may be a square or rectangle, or it may be in the form of an elongated strip. The patch may have a complex shape with a variety of perimeter shapes that correspond to the shape of the surface area to which it will be bonded.

In one aspect, the patch 20 is bonded to the substrate 22 when the substrate in its “blank” form, meaning the form of the substrate prior to being stamped, formed, or otherwise shaped into its final structural shape. In this aspect, the patch 20 may have a shape that does not necessarily match the shape of the area where the patch 20 will ultimately exist in the final form of the component. The final shape of the structural component may then be stamped or cut from the bonded patch 20 and substrate 22 combination.

In another aspect, the patch 20 may be bonded to the substrate 22 after the substrate 22 has been stamped or otherwise formed/shaped into its final component shape. In this aspect, the patch 20 may be shaped to correspond to the shape of the area to which it will be applied. However, the patch 20 may also have a non-matching shape, and the patch may be further processed to remove excess material that does not correspond to the final shape of the substrate 22 or the bonded area.

The patch 20 may have a variety of thicknesses. It one aspect, the patch 20 may be up to 4 mm thick with chassis grade steel (HR340LA). However, other thicknesses may also be used, such as 1 mm, 2 mm, 3 mm. Additional thickness ranges may also be possible with other materials.

In one aspect, the speed of the wheels 24 may be controlled during the bonding process. In one example, 250 mm/min may be the speed at which the wheels 24 travel to heat and bond the patch 20 to the substrate 22. In another example, 1 m/min may be used for an increased speed, which is possible with HR340LA. The pass width may, in one aspect, be 10-20 mm. The current applied by the wheels 24 may be up 22 kA. The current that is used may depend on the speed that is used.

In one example, using a 6×6 inch patch 20 with a 2 mm thickness and using four weld heads/wheels 24, the total contact time between the wheels 24 and the patch 20 is 18.4 seconds when bonding the patch 20 to the substrate 22 in the form of a blank.

In one example, illustrated in FIG. 9, the patch 20 may be in the form of Iconel clad onto a substrate 22 of 19 mm steel in blank form. The brazing material of the bonding layer 23 may be a Nickle-Phosphate braze alloy. In this example, 100% bonding was seen from pass to pass. The bonding was accomplishing using 200-kVA resistance seam welding with 20-kN max force. The bonding layer 23 was 11 micrometers. The speed was 250 mm/min. The 1 mm patch 20 yielded a shear strength of 345 and 352 MPa. For a 2 mm patch 20, shear strengths of 498 MPa and 388 MPa were achieved.

In further examples, shown in FIGS. 10-17, 2 mm thick uncoated patches 20 and 2 mm thick galvanized patches 20 may be used along with a 200 kVa resistance seam welding machine. The wheel 24 may be 12 mm wide with a 290 mm diameter. The patches 20 may include 11 micrometer thick electroless nickel plating to serve as the braze material or bonding layer 23, which melts at 870 degrees C. The bonding process may result in a 5 micrometer thick weld nugget 25 or bond after bonding. A speed of 0.61 m/min may be used with a force of 6.67 kN, and a current of 18 kA.

The material of the patches 20 and substrate 22 may be HR340LA, either galvanized (coated) or uncoated. In one aspect, the substrate 22 may be 2 mm thick, with an additional 2 mm added via the patches 20. The combined substrate 22 and patches 20, after bonding, may be resistant to tension, lap shear, and 4-point bending, which provides confirmation of a successful bond therebetween.

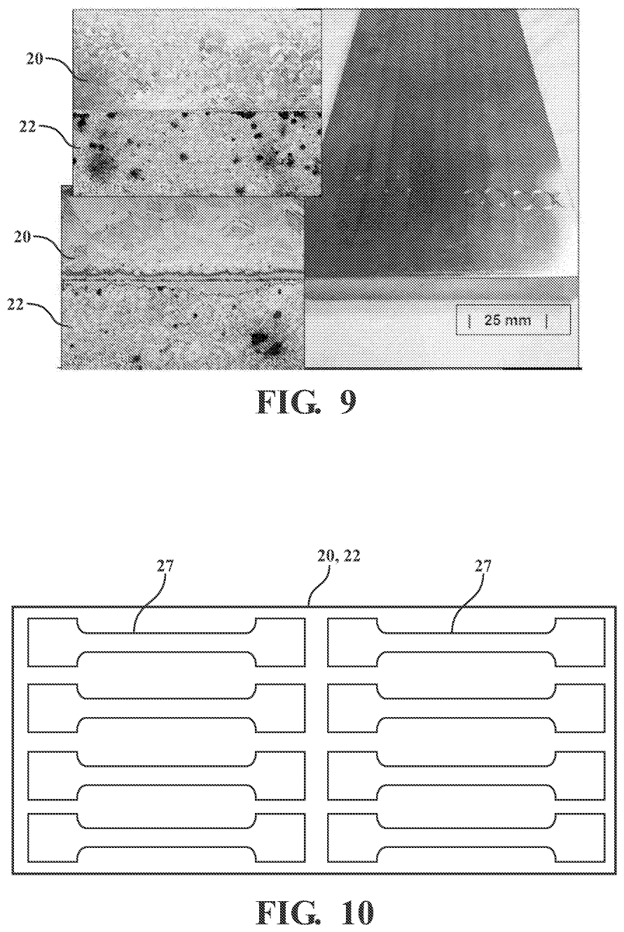

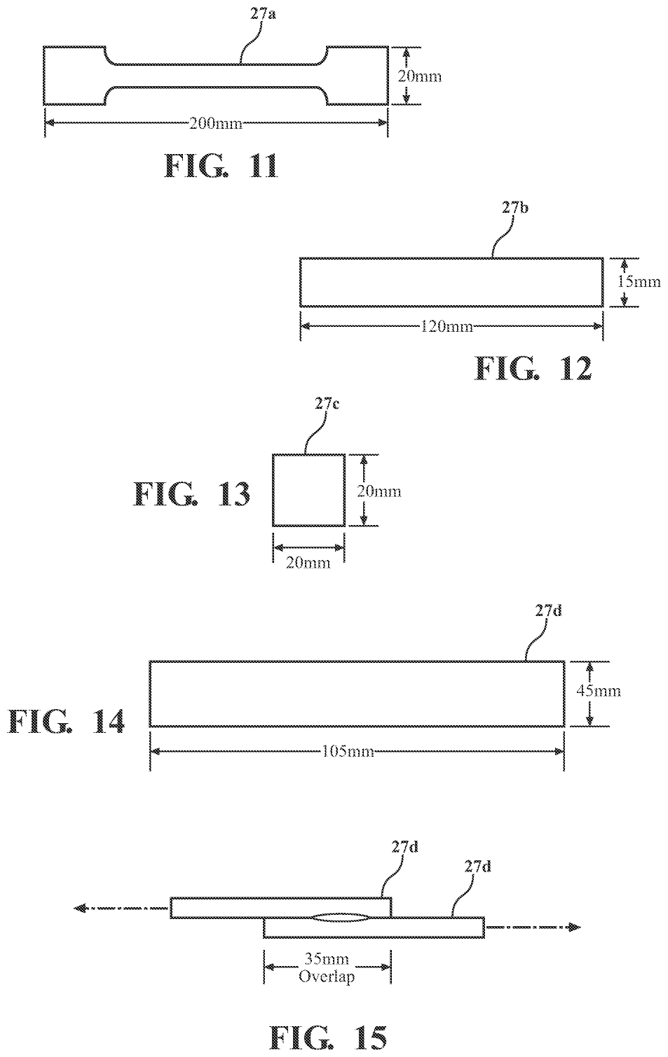

In one aspect, shown in FIG. 10, the patch 20 may be bonded to the substrate 22 in blank form, with coupons 27 cut from the combined patch 20 and substrate 22 after bonding. The coupons 27 may then undergo testing to confirm the strength of the bond formed between the patch 20 and the substrate 22. In one aspect, a coupon 27a (FIG. 11) may be approximately 200 mm long and 20 mm wide, having a final thickness of 4 mm, which may be subjected to tensile testing. In another aspect, a coupon 27b (FIG. 12) may be 120 mm long and 15 mm wide, which may be subjected to flexural testing. In another aspect, a coupon 27c (FIG. 13) may be 20 mm×20 mm, which may be subjected to micrograph testing. In another aspect, a coupon 27d (FIGS. 14 and 15) may be 105 mm long and 45 mm wide, which may be subjected to lap shear testing. In the lap shear testing, 35 mm of overlap may be created. It will be appreciated that these dimensions are exemplary and intended to illustrate the effectiveness of the full surface bond, and that other relative dimensions and shapes may be used depending on the component and the area where added stiffness of strength is desired.

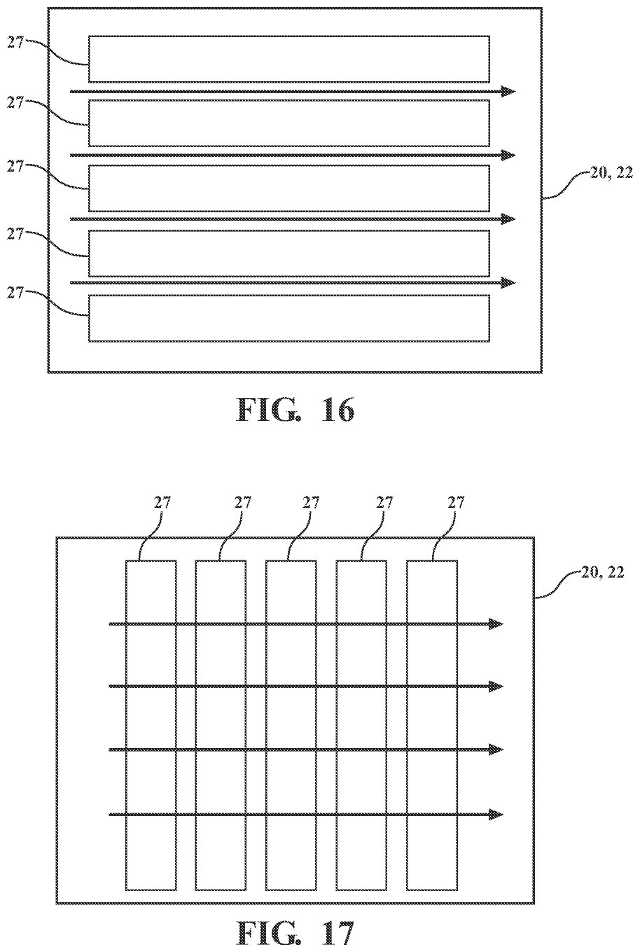

The coupons 27 may be cut from the combined patch 20 and substrate 22 in the direction of the rolling force applied by the wheel 24 (FIG. 16), or they may be cut transverse to the rolling direction (FIG. 17). The arrows of FIGS. 16 and 17 represent the rolling direction of the wheel 24. In both instances, the coupons 27 exhibit high strength properties. The coupons 27 cut in the direction of the rolling (show in FIG. 16) may exhibit, on average, approximately 50 mpa higher UTS than those cut transverse to the rolling direction. Upon inspection via micrograph, full wetting and surface contact of the braze layer may be achieved. In each of the above tests, the majority of coupons 27 exceeded the strength or stiffness target, which may approximately 90% of the strength/stiffness of an equal thickness single component.

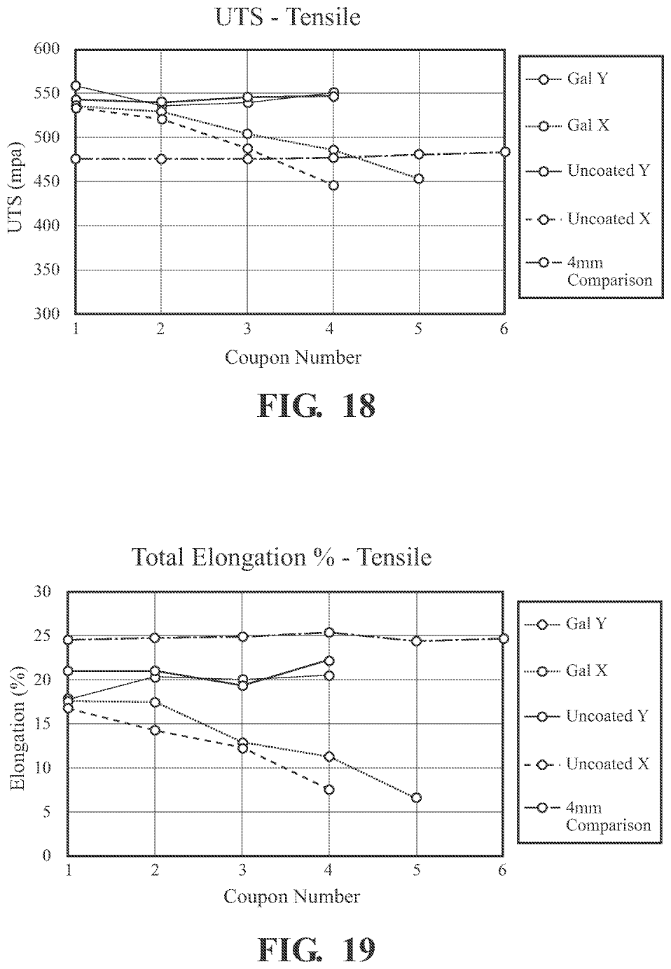

FIG. 18 illustrates a graph of the UTS tensile tests of the coupons 27a, for both galvanized and uncoated coupons 27a, and compared to a solid 4 mm coupon. The solid 4 mm coupon exhibits approximately the same UTS for coupons 1-6.

FIG. 19 illustrates total elongation of the coupons 27a in the tensile testing. The solid 4 mm coupon exhibits approximately the same 25% elongation for coupons 1-6.

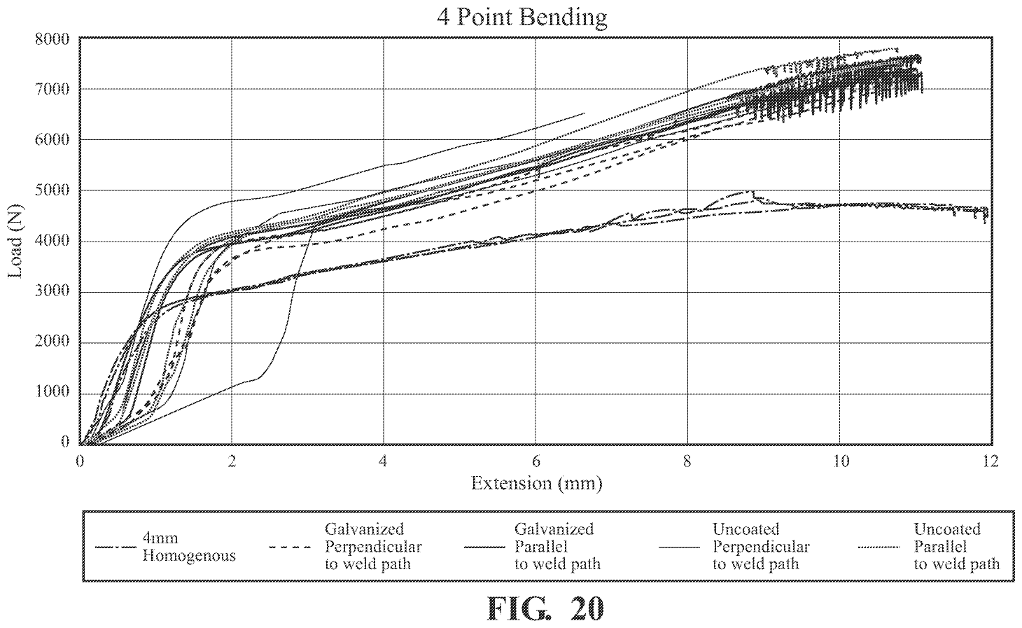

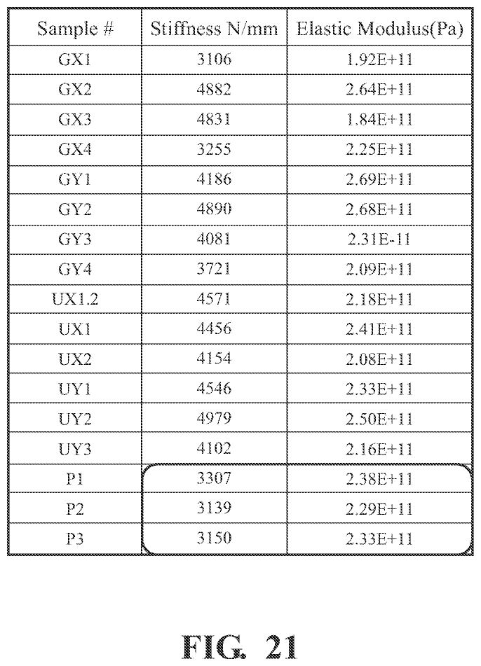

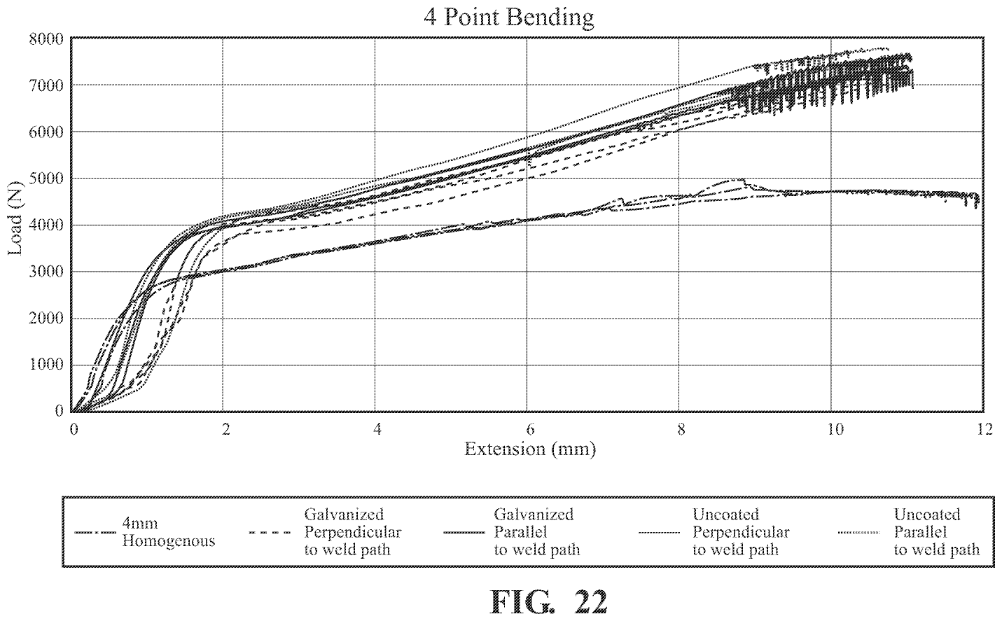

FIGS. 20-22 illustrate the results of 4 point bending. The solid 4 mm coupons are shown separated and lower than the other coupons as extension increases in both FIGS. 20 and 22. FIG. 22 corresponds to FIG. 20, but with the uncoated and perpendicular to the weld path coupons removed for clarity. FIG. 21 provides a table illustrating the resulting stiffness and elastic modulus for the various coupons.

FIGS. 23A and 23B illustrates results of micrographs to examine both uncoated and galvanized samples, illustrating the weld nugget 25 and resulting full braze contact

As described above, larger surface areas relative to the size of the wheel 24 may be accomplished using multiple passes of the wheel 24. The multiple passes may be applied simultaneously or staggered within a short period of time. This approach provides time savings relative to conducting subsequent passes after the bond has cooled.

As described above, the patch 20 may be applied to the substrate 22 in blank form, where stamping may occur at a later time. However, the patch 20 may also be applied to a pre-stamped substrate in some instances, depending on the shape of the substrate 22 after stamping or forming.

The use of the patches 20 bonded to the substrate 22 provides additional advantages beyond the increased stiffness. For example, the addition of patches 20 to the substrate 22 increases corrosion resistance. Moreover, the thickness of the combined substrate 22 and patch 20 can be further increased in the event of a modified stiffness requirement, which may require an additional thickness beyond what was initially intended. For example, an initial design requirement may call for a first stiffness requirement in a particular location on a vehicle structural component. However, a design change at a later time and after manufacturing of the base structural component has begun may require additional stiffness in an isolated area. The existing structural component can be modified with the fully bonded stiffening patch 20 described herein

In one aspect, the thickness of the substrate 22 may be the minimum desired gauge of the cradle 12. In one example, the thickness of the substrate 22 may be 1 mm. The thickness of the patch 20 may be the difference between the desired gauge or thickness in the area of the patch 20 and the thickness of the base substrate 22. Accordingly, prior examples of FIGS. 1-4, for the zone 18 where a 2 mm thickness is used, the patch 20 may be 1 mm thick and applied to the 1 mm substrate 22. For the zone 18 that is 5 mm thick, the patch 20 may be 4 mm thick and applied to the 1 mm substrate 22.

However, in another aspect, multiple patches 20 may be applied in a stack to reach the desired overall thickness. For example, for a 5 mm zone, four 1 mm thick patches 20 may be applied to the 1 mm thick substrate 22.

Accordingly, the use of the patches 20 in localized areas allows for the ability to create parts, such as the cradle 12, with a variable thickness throughout. The patches 20 may be used to locally thicken various portions of the sub-frame or cradle 12. By using defined stiffness targets for the cradle 12, free-size gauge optimization may be used to identify areas or zones 18 of the sub-frame or cradle 12 that can benefit from varying thickness. Accordingly, if a single area or zone 18 requires an increased gauge or thickness, it may be locally thickened rather than having to increase the gauge or thickness of the entire component, thereby saving on overall mass and increasing product performance.

According to analysis of this approach, a perimeter type cradle 12 may save about 8% of mass, and a k-frame type cradle may save from 1-5% of mass when using the patches 20. For an infinitely variable gauge or thickness design with gauges ranging from 1.6-5 mm, perimeter cradles 12 may save 14% of mass, with k-frame cradles 12 saving about 11%.

Thus, in view of the above, the structural component 12 having localized patches may provide the necessary stiffness of a typical component, but with reduced mass, by having localized areas or zones 18 with increased thickness created by the fully bonded patches 20. The increased thickness may be greater than the baseline or original thickness of the typical component, allowing for reduced thicknesses in other areas.

Accordingly, a component 12 may have sections 14 that define a shape of the component 12. The sections 14 may have a first thickness disposed along a first portion of the sections 14, wherein the first thickness is a minimum thickness of the cradle 12. The sections 14 may further include a second thickness disposed at a second portion of the section 14. The sections 14 may further include a third thickness disposed at a third portion of the sections 14, wherein the third thickness is a maximum thickness of the component 12. The second thickness may be greater than the first thickness and less than the third thickness. In one aspect, the second and third thicknesses are defined by a patch 20 applied to the section 14, such that the combined thickness of the section 14 and the patch 20 defines the thickness of the section 14.

In another aspect, the variable thickness of the component 12 may be accomplished by other manufacturing methods other than patches. For example, metal deposition techniques, such as cold spray or sintering, may be used to add thickness to identified local zones 18 of the component 12.

In another aspect, the above-described variable gauge or thickness may be applied to other structural components of the vehicle other than the illustrated component 12. For example, the variable gauge approach may be applied to frame rails, B-pillars, and the like.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

1. A vehicle structural component comprising:
a substrate of the vehicle structural component, the substrate having a substrate thickness;
at least one patch member having a size and shape smaller than the substrate, the at least one patch member having a patch thickness;
wherein the at least one patch member is bonded to the substrate via a full surface bond between the patch member and the substrate; and
wherein a total thickness of the vehicle structural component includes the patch thickness and the substrate thickness at the location of the patch member.

2. The vehicle structural component of claim 1, further comprising a bonding layer disposed between the patch member and the substrate.

3. The vehicle structural component of claim 2, wherein the bonding layer is brazed and fully wetted between the patch member and substrate.

4. The vehicle structural component of claim 2, wherein the bonding layer is an adhesive layer.

5. The vehicle structural component of claim 1, wherein the at least one patch member is bonded to the substrate via resistance seam welding.

6. The vehicle structural component of claim 1, wherein the stiffness and tensile strength of the structural component at the location of the patch member is at least 90% of the stiffness and tensile strength of a single component having a thickness equal to the total thickness of the patch and the substrate.

7. The vehicle structural component of claim 1, wherein the thickness of the structural component varies.

8. The vehicle structural component of claim 7, wherein the thickness of the substrate defines a minimum thickness of the structural component.

9. The vehicle structural component of claim 8, wherein the stiffness at the minimum thickness of the substrate is less than the stiffness at a location of the patch.

10. A method of providing variable thickness to a vehicle structural component, the method comprising:
providing a substrate having a substrate thickness;
providing a patch having a patch thickness;
applying the patch to the substrate; and
fully bonding the patch to the substrate.

11. The method of claim 10, wherein the patch includes a bonding layer disposed on the surface of the patch and the bonding layer is disposed between the patch and the substrate.

12. The method of claim 10, wherein the patch is bonded to the substrate via resistance seam welding.

13. The method of claim 10, wherein the patch is bonded to the substrate via adhesive bonding.

14. The method of claim 10, wherein the patch is bonded to the substrate via brazing.

15. The method of claim 10 further comprising applying at least one pair of conductive weld wheels against the patch and the substrate on opposite sides thereof and applying current and pressure thereto.

16. The method of claim 15, wherein the at least one pair of weld wheels comprises a single pair of weld wheels, the method further comprising applying the single pair of weld wheels along a first path to create a first weld nugget along the first path, and applying the single pair of weld wheels along the second path to create a second weld nugget.

17. The method of claim 16, wherein the first and second path are parallel and adjacent, such that the first and second weld nuggets combine to define a continuous surface bond.

18. The method of claim 15, wherein the at least one conductive weld wheel comprises:
a first pair of weld wheels being radially aligned and defining a first space radially therebetween; and
a second pair of weld wheels being radially aligned and defining a second space radially therebetween;
wherein the first and second pairs of weld wheels are offset laterally and roll in the same direction;
wherein the first and second pairs of weld wheels are configured to receive a patch and a substrate within the first and second space simultaneously.

19. A system for creating a full surface bond between a substrate and a patch, the system comprising:
a first pair of conductive weld wheels configured to perform resistance seam welding and being radially aligned and defining a first space radially therebetween; and
a second pair of conductive weld wheels configured to perform resistance seam welding being radially aligned and defining a second space radially therebetween;
wherein the first and second pairs of weld wheels are offset laterally and roll in the same direction;
wherein the first and second pairs of weld wheels are configured to receive a patch and a substrate within the first and second space simultaneously.

20. The system of claim 19, wherein the first and second pairs of weld wheels are axially offset.

21. The system of claim 19, wherein the first and second pairs of weld wheels are axially aligned.
